(19) United States
(12) Patent Application Publication
(10) Pub. No.: US 2017/0177895 A1
(43) Pub. Date: Jun. 22, 2017

(54) IN-SITU CLOUD DATA MANAGEMENT SOLUTION

(71) Applicant: Datanomix, Inc., Brookline, NH (US)

(72) Inventor: Gregory J. McHale, Brookline, NH (US)

(21) Appl. No.: 15/386,008

(22) Filed: Dec. 21, 2016

Related U.S. Application Data
(60) Provisional application No. 62/270,338, filed on Dec. 21, 2015.

(51) Int. Cl. G06F 21/62; G06F 21/60

(52) U.S. Cl. CPC G06F 21/6218; G06F 21/604

(57) ABSTRACT

A data management solution using data management nodes which in turn are connected to one or more data storage entities. Data management nodes receive access requests from software connector components that run in-situ on application or file servers, and store file system meta-data and custom defined meta-data that may include policies and requirements. An object store, which may be accessible via a database, associates said meta-data with files, file systems, users, application servers, file servers, and file data objects. Data objects containing file data are stored on one more of a heterogeneous set of external data storage entities which may be in the cloud. Requirements may be tracked over time by the data management node, and used to optimize data object placement. Data storage entities may be added or removed in a non-disruptive manner.

### RELATED APPLICATIONS

The present application claims priority to U.S. Provisional Patent Application No. 62/270,338, filed on Dec. 21, 2015 by Gregory J. McHale for a “FLEXIBLY DEPLOYABLE STORAGE ENTITIES IN A POLICY AND REQUIREMENTS AWARE DATA MANAGEMENT ECOSYSTEM WITH DECOUPLED FILE SYSTEM META-DATA AND USER DATA”, the contents of which are incorporated by reference herein in their entirety.

### BACKGROUND

Technical Field

This patent application relates to data storage systems, and more particularly to methods and systems for implementing an in-situ data management solution.

Background Information

The growth and management of unstructured data is perceived to be one of the largest issues for businesses that purchase and deploy data storage. Unstructured data is anticipated to grow at a rate of 40-60% per year for the next several years, as the proliferation of content generation in various file formats takes hold, and that content is copied multiple times throughout data centers.

Enterprises are already starting to feel the pain of this rapid data growth, and are looking for ways to store, manage, protect and migrate their unstructured data in a cost effective manner without needing to manage increasing volumes of hardware.

Conventionally, these enterprises purchase data storage assets in an appliance form factor, often needing to migrate data from one set of monolithic appliances to another as their data needs grow and scale. This approach is capital intensive, as storage appliances cost in the thousands of dollars per terabyte, and data migration projects routinely overrun their intended timeframes and incur additional service costs as a result.

The Public Cloud would seem to be one place to look for relief from such challenges, but a variety of objections stand between legacy storage appliances and Public Cloud adoption: data privacy concerns, data lock-in, data egress costs, complexity of migration, and the inability to make an all-or-none architecture decision across a diverse set of applications and data.

### SUMMARY

The in-situ cloud data management solution(s) described herein offer the ability to decouple applications and data from legacy storage infrastructure on a granular basis, migrating the desired data to a cloud architecture as policies, readiness, and needs dictate, and in a non-disruptive fashion. In so doing, the in-situ data management solution(s) allow consolidating no fewer than what are typically a half dozen products and data management functions into a single system, scaling on-demand, and shifting capital expenditure (CAPEX) outlays to operational expenditures (OPEX) while substantially reducing total cost of ownership (TCO).

In one implementation, an in-situ cloud data management solution may be comprised of one or more application or file servers, each running one or more software connector components, which in turn are connected to one or more data management nodes. The data management nodes are in turn connected to one more data storage entities.

The connector components may be installed into application or file servers, and execute software instructions that intercept input/output (I/O) requests from applications or file systems and forward them to one or more data management nodes. The I/O requests may be file system operations or block-addressed operations to access data assets such as files, directories or blocks. The I/O intercepts may be applied as a function of one or more policies. The policies may be defined by an administrative user, or may be automatically generated based on observed data access patterns.

The data management nodes execute software instructions implementing application and file system translation layers capable of interpreting requests forwarded from software connectors. The data management nodes also may include a database of object records for both data and meta-data objects, persistent storage for meta-data objects, a data object and meta-data cache, a storage management layer, and policy engines.

The data management nodes may store file system and application meta-data in a database as objects. Along with the conventional attributes commonly referred to as file system meta-data (i.e. the Unix stat structure), the database may be used to associate i-node numbers with file names and directories using a key-value pair schema.

Files, directories, file systems, users and application and file servers may have object records in the database, each of which may be uniquely identified by a cryptographic hash or monotonically increasing number.

Contents of files may be broken into variable sized chunks, ranging from 512 b to 10 MB, and those chunks are also assigned to object records, which may be uniquely identified by a cryptographic hash of their respective contents. The chunks themselves may be considered to be data objects. Data objects are described by object records in the database, but are not themselves stored in the database. Rather, the data objects are stored in one or more of the data storage entities.

File system meta-data in the database points to the data object(s) described by that meta-data via the unique identifiers of those objects.

The data storage entities may typically include cloud storage services (i.e. Amazon S3 or other Public Cloud. Infrastructure as a Service (IaaS) platforms in Regional Clouds), third party storage appliances, or in some implementations, one or more solid state disks, or one or more hard drives. The data management nodes may communicate with each other, and therefore, by proxy, with more than one data storage entity.

The database accessible to the data management node may contain a record for each object consisting of the object's unique name, object type, reference count, logical size, physical size, a list of storage entity identifiers consisting of {the storage entity identifier, the storage container identifier (LUN), and the logical block address}, a list of children objects, and/or a set of custom object attributes pertaining to the categories of performance, capacity, data optimization, backup, disaster recovery, retention, disposal, security, cost and/or user-defined meta-data.

The custom object attributes in the database contain information that is represented as object requirements and/or object policies.

The database may also contain storage classification information, representing characteristics of the data storage entities accessible to data management nodes for any of the aforementioned custom object attributes.

Object requirements may be gathered during live system operation by monitoring and recording information pertaining to meta-data and data access within the file system for any of the aforementioned custom attribute categories. In this case, object attributes may be journaled to an object attribute log in real-time and subsequently processed to determine object requirements and the extent to which those requirements and/or policies are being satisfied.

Object requirements may also be gathered by user input to the system for any of the aforementioned attribute categories.

Object policies may be defined by user input to the system for any of the aforementioned attribute categories, and may also be learned by interactions between the software connector(s) and data management node(s), wherein the data management node may perform its own analysis of the requirements found within the custom object attribute information.

Requirements and policies may be routinely analyzed by a set of policy engines to create marching orders. Marching orders reflect the implementation of a policy with respect to its requirements for any object or set of objects described by the database

When the data storage entities are unable to meet the requirements and/or fulfill the policies, the data management node may describe and/or provision specific data storage entities that are additionally required to meet those needs.

If the required data storage entities to meet those needs are virtual entities, such as data volumes in a Public Cloud, or data volumes on a third party storage appliance (IaaS or otherwise), the data management node can provision such virtual entities via an Application Programming Interface (API), and the capacity and performance of those entities is immediately brought online and is usable by the data management node.

Objects may be managed, replicated, placed within, or removed from data storage entities as appropriate via the marching orders to accommodate the requirements and policies associated with those objects.

File system disaster recovery and redundancy features may also be implemented, such as snapshots, clones and replicas. The definition of data objects in the system enables the creation of disaster recovery and redundancy policies at a fine granularity, specifically sub-snapshot, sub-clone, and sub-replica levels, including on a per-file basis.

Features and Advantages:

The disclosed system has a number of advantageous features, it being understood that not all embodiments described herein necessarily implement all described features.

The disclosed system may operate in-situ of legacy application and file servers, enabling all described functionality with simple software installations.

The disclosed system may allow for an orderly and granular adoption of cloud architectures for legacy application and file data with no disruption to those applications or files.

The disclosed system may decouple file system meta-data and user data in a singularly managed cloud data management solution.

The disclosed system may allow for the creation and storage of custom meta-data associated with users, application and file servers, files and file systems, enabling the opportunity to create data management policies as a function of that custom meta-data.

The disclosed system may store requirements and service level agreements for users, application and file servers, files, and file systems, and can implement policies to accommodate them at equivalent granularities and custom subsets of granularities.

The disclosed system may enable data storage entities that are classically used for the storage of application and file data to be deployed independently of the entities used for data management and file system meta-data storage.

The disclosed system may allow for the mobility of meta-data required for applications or users to access data independent of the location of storage entities housing the actual data.

The disclosed system may create a truly granular pay-as-you-grow consumption model for data storage entities by allowing for the flexible deployment of one more data storage entities in an independent manner.

The disclosed system may create the opportunity to dispose of legacy data storage entities and replace them with more cost effective, enterprise quality, commodity components, whether physical or virtual, at a greatly reduced total cost of ownership (TCO).

The disclosed system may allow for mobility of data objects across different data storage assets, including those in various clouds, in the most cost-effective possible manner that meets prescribed requirements and service level agreements.

The disclosed system may eliminate the need for data storage migration projects.

The disclosed system may free enterprises from the concept of vendor lock-in with their data storage assets, whether physical or virtual.

The disclosed system may allow enterprises to optimize their data sets, via technologies such as deduplication and compression, globally, across all data storage entities being used for the storage of their data.

The disclosed system may enable fine-grained data management policies on backup copies of data, specifically at sub-snapshot, sub-clone, and sub-replica granularity, creating the opportunity to optimize storage requirements and costs for backup data.

The disclosed system may collapse several data storage and data management products into a single, software only offering.

### BRIEF DESCRIPTION OF THE DRAWINGS

The description below refers to the accompanying drawings, of which:

FIG. 1 is a diagram of one embodiment of an in-situ cloud data management solution, consisting of one or more application or file servers, one or more data management nodes arranged in a cluster, and one or more data storage entities.

FIG. 2 is a block diagram of one embodiment of a data management node.

FIG. 3 is a representation of an object record.

FIG. 4 is a block diagram of one embodiment of the flow of data from an application or file server through a data management node to a storage entity.

FIG. 5 is an example implementation of an object requirement.

FIG. 6 is a flow chart depicting the process of how the system routinely assesses object requirements and automatically deploys data storage entities to accommodate a change in requirements.

FIG. 7 is a flow chart depicting the process of how to dispose of a legacy storage entity.

FIG. 8 is a flow chart depicting the process of using custom, user-defined meta-data to define and fulfill a data management policy

FIG. 9 is a flow chart reflecting the process of mobilizing the meta-data, and thereby access, of a file set independent of the data storage location.

FIG. 10 is an alternative implementation of a cloud data management system which achieves many of the same benefits.

### DETAILED DESCRIPTION OF AN ILLUSTRATIVE EMBODIMENT

The following is a detailed description of an in-situ data management solution with reference to one or more preferred embodiments. It will be understood however by those skilled in the art that various changes in form and details may be made therein without departing from the spirit and scope of the invention(s) sought to be protected by this patent.

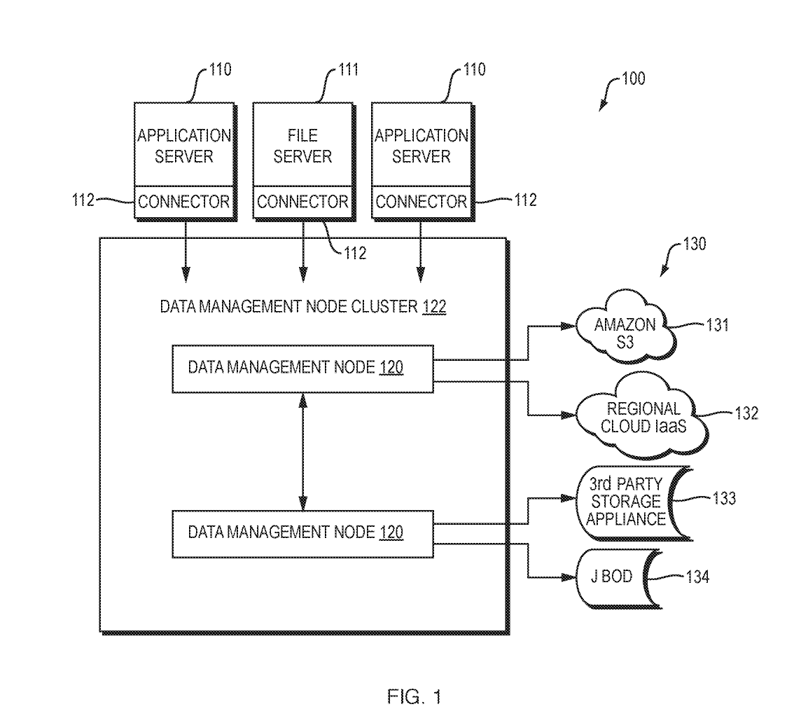

FIG. 1 is one example embodiment of an in-situ cloud data management solution 100. The illustrated in-situ cloud data management solution 100 is comprised of one or more application 110 or file servers 111, each with one or more software connector components 112. The connector components 112 connect to one or more data management nodes 120, and data management nodes connect to one or more data storage entities 130.

Connector components 112 may reside as software executing on one or more application 110 or file servers 111. Connector components 112 may exist as filter drivers or kernel components within the operating system of the application 110 or file servers 111, and may, for example, run on either Windows or Linux operating systems. The connector components 112 may intercept block level or file system level requests and forward them to the data management node 120 for processing. Connector components 112 preferably only forward requests for data assets that the data management node 120 has taken ownership of, either through explicit administrator action or policy.

When software connector components 112 are first installed into an application 110 or file server 111, they typically do not initially intercept or interfere with any Input/Output (I/O) requests on that application or file server. It is only through subsequent action taken on a data management node 120, set via administrator or policy, that indicates to the connector 112 whether it should take over ownership of a “data asset” such as a file, directory, file set, or application's data. Upon doing so, the connector 112 may make use of an existing file system mechanism in the operating system, such as an NTFS reparse point, to redirect the I/O request to the data management node.

Ownership of an asset may be indicated to the connector component 112 in a number of ways. In one example, the connector component 112 receives a command from the data management node 120 to assume ownership and thus responsibility for processing access requests to one or more data assets accessible to the server 110 or application 111. The connector component 112 may then store a persistent cookie, or some other data associated with the one or more affected data assets. Thus, upon subsequent processing of an access request related to a specific data asset, if a persistent cookie is found, then the software component knows to forward the access request to the data management node. Otherwise, the remote device will process the access request locally, without forwarding the access request to the data management node.

Multiple data management nodes 120 are typically present for the purposes of redundancy. Data management nodes 120 can exist in a cluster 122 or as standalone entities. If in a cluster 122, data management nodes 120 may communicate with each other via a high speed, low latency interconnect, such as 10 Gb Ethernet.

Data management node(s) 120 also connect to one or more data storage entities 130.

Data storage entities 130 may include any convenient hardware, software, local, remote, physical, virtual, cloud or other entity capable of reading and writing data including but not limited to individual hard disk drives (HDD's), solid state drive (SSD's), directly attached Just a Bunch of Disks (JBOD) enclosures 134 thereof, third party storage appliances 133 (i.e. EMC, SwiftStack), file servers, and cloud storage services (i.e. Amazon S3 131, Dropbox, OneDrive, IaaS 132, etc.).

Data storage entities 130 can be added to the data management solution 100 without any interruption of service to application 110 or file 111 servers, and with immediate availability of the capacity and performance capabilities of those entities 130.

Data storage entities 130 can also be targeted to be removed from the data management solution 100, and after data is transparently migrated off of those data storage entities (typically onto one or more other data storage entities). The data storage entities 130 targeted for removal can then be disconnected from the data management solution without any interruption of service to application or file servers. For example, the content of JBOD entities 134 may be migrated to Amazon S3 131 or cloud storage 132 using the techniques described herein.

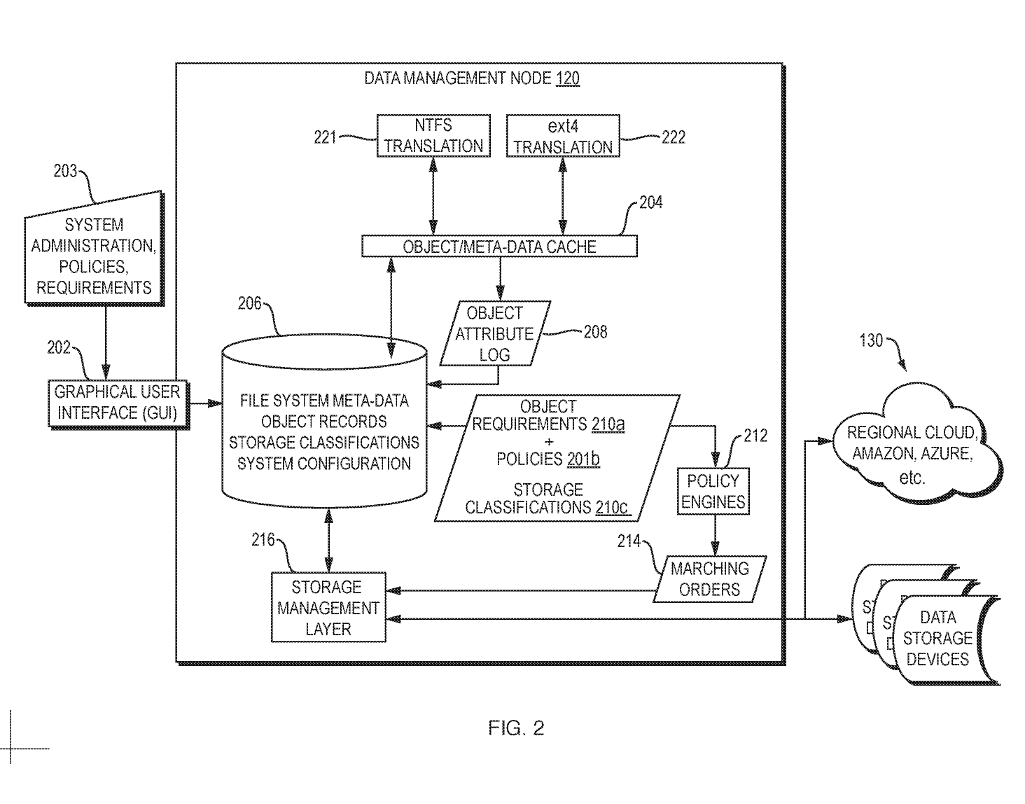

FIG. 2 is an example embodiment of a data management node 120 in more detail.

A data management node 120 may be a data processor (physical, virtual, or more advantageously, a cloud server) that contains various translation layers—for example, one layer for each supported file system—that interpret a stream of native I/O requests routed from a file 110 or application 110 server via one or more connector components 112.

A data management node 120 may be accessed via a graphical user interface (GUI) 202. This GUI 202 may be used to perform administrative functions 203, such as system configuration, establishing relationships with file 111 and application 110 servers that have software connector components 112 installed, integrating with data storage entities 130 (whether cloud services or third party storage appliances or otherwise), and setting and configuring policies with respect to data management functions.

A data management node 120 may contain an object cache and a meta-data cache 204, which contain non-persistent copies of recently or frequently accessed data objects and/or file system meta-data objects.

A data management node 120 may also contain a database 206 which contains file system meta-data and object records for files and data objects known to the data management node 120, and storage classification data for the connected data storage entities 130. Contents of meta-data objects may persistently reside in local storage associated with the database 206, however contents of data objects persistently reside on data storage entities 130 that are connected to the data management node(s). Thus, the storage of file system meta-data and file data are decoupled in the context of data management node 120.

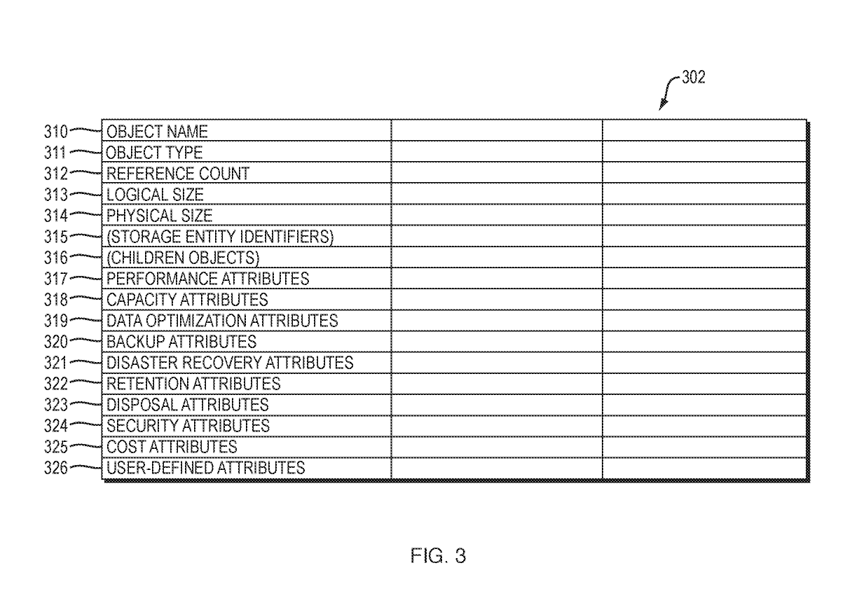

File system meta-data in one embodiment may refer to a standard set of file attributes such as those found in POSIX compliant file systems. A meta-data object record in this embodiment may refer to a custom data structure, an example of which is shown in FIG. 3. An object record 302 which contains the target object's unique name 310 (cryptographic hash), object type 311, reference count 312, logical size 313, physical size 314, and source server location or other storage entity identifiers—collectively, storage entity identifier 315, storage container identifier (LUN or volume), or storage block address (LBA). Also included may be a list of children objects 316, and customized object attributes pertaining to the categories of performance 317, capacity 318, data optimization 319, backup 320, disaster recovery 321, retention 322, disposal 323, security 324, cost 325 and other user-defined meta-data attributes 321.

Storage classification 210C refers to a set of information on a per data storage entity 130 basis that reflects characteristics pertinent to the custom object attribute categories. In one example, these may be performance 317, capacity 318, security 324, cost 325, and user-defined 326, although myriad other storage classifications 210C may be defined.

A data management node 120 may contain an object attribute log 208 which represents activity relative to the object requirements 210A and object policies 210B, including custom object attribute categories, as recorded by the data management node 120. This object attribute log 208 is used to create or update custom object attribute meta-data within the database 206. Example attribute log entries may pertain to access speed, as expressed in latency, frequency of access or modification, as expressed in number of accesses or modifications per unit of time. Entries within the object attribute log 208 pertaining to a single object and single attribute category may be consolidated into a single attribute log entry so as to optimize database update operations. Processed object attribute log information stored in the database 206 may subsequently be fed to the policy engines 212 as object requirements 210A or object policies 210B.

A data management node 120 may also generate object requirements 210A and object policies 210B based on custom object attributes that are stored in the database 206. Object requirements 210A are either gathered via user input or generated automatically by the data management node. When generated automatically, object requirements 210A may be gathered during live system operation by monitoring and recording information pertaining to meta-data and data access within the file system. Object policies 210B may be defined by user input to the data management node, and may also be learned by the data management node 120 performing its own analysis of the requirements found within the custom object attribute information.

A data management node 120 may also contain a set of policy engines 212 which take object requirements 210A, object policies 210B and storage classifications 210C as input and generate a set of marching orders 214 by performing analysis of said inputs. Storage classifications 210C may consist of both real-time measured and statically obtained data reflecting capabilities of the underlying data storage entities. For instance, performance capabilities of a given storage entity 130 may be measured in real-time, and utilization calculations are then performed to determine the performance capabilities of said entity. Capacity information, however, may be obtained statically by querying the underlying storage entity 130 via publicly available API's, such as OpenStack. Marching orders 214 may reflect the implementation of a policy with respect to its requirements for any object or set of objects described in the database 206. More specifically, marching orders 214 may describe where and how objects should be managed or placed within, or removed from, the data management solution 100.

The data management node 120 may also contain a storage management layer 216 which manages the allocation and deallocation of storage space on data storage entities within the solution 100. The storage management layer 216, therefore, is responsible for implementing the marching orders it is presented with by the policy engines. In order to fulfill this obligation, the storage management layer has access to information concerning the characteristics and capabilities of the underlying data storage entities 130 with respect to the custom object attribute categories previously defined, and creates storage classifications on those dimensions, which in turn are stored in the database 206. Thusly, marching orders 214 clearly describe an object or object set, the operation, and the associated data storage entity or entities to be targeted by each operation.

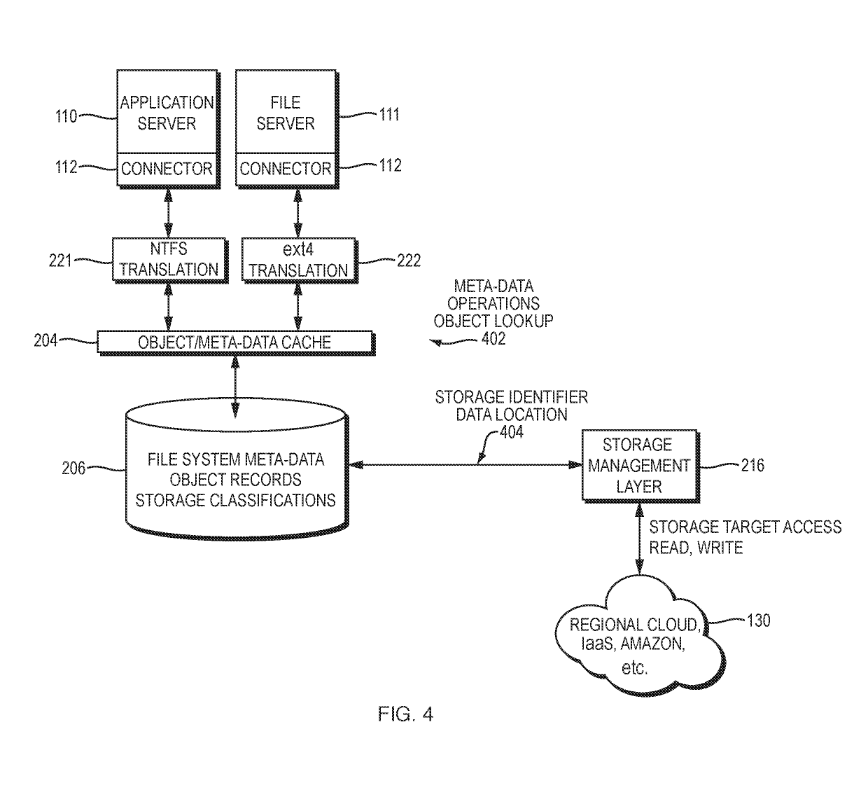

FIG. 4 is a block diagram representing one example flow of user data from an application or file server through the data management node 120 to a data storage entity 130. In this example, a data access request is received from either an application 110 or file server 111 via the in-situ software connector component 112, as described above. That data access, retrieved by the data management node 120, is then translated by a shim layer (e.g., NTFS 221 or ext4 222) specific to the type of file system or application that the request came from. Meta-data operations associated with the data access request are passed to the database 206. Once the file to be accessed is identified, its associated object in the database 206 is found via object lookup 402, and then the data range to be accessed is determined from the data access request. From there, data objects associated with the data request are looked up in the database 206, and their storage entity identifiers 404 are furnished. The storage entity identifier information is then passed to the storage management layer 216, which accesses the necessary data storage entities 130 at the appropriate locations to store or retrieve the associated data. At this point, the data management node may cache to contents of either meta-data objects or data objects in the object/meta-data cache 204.

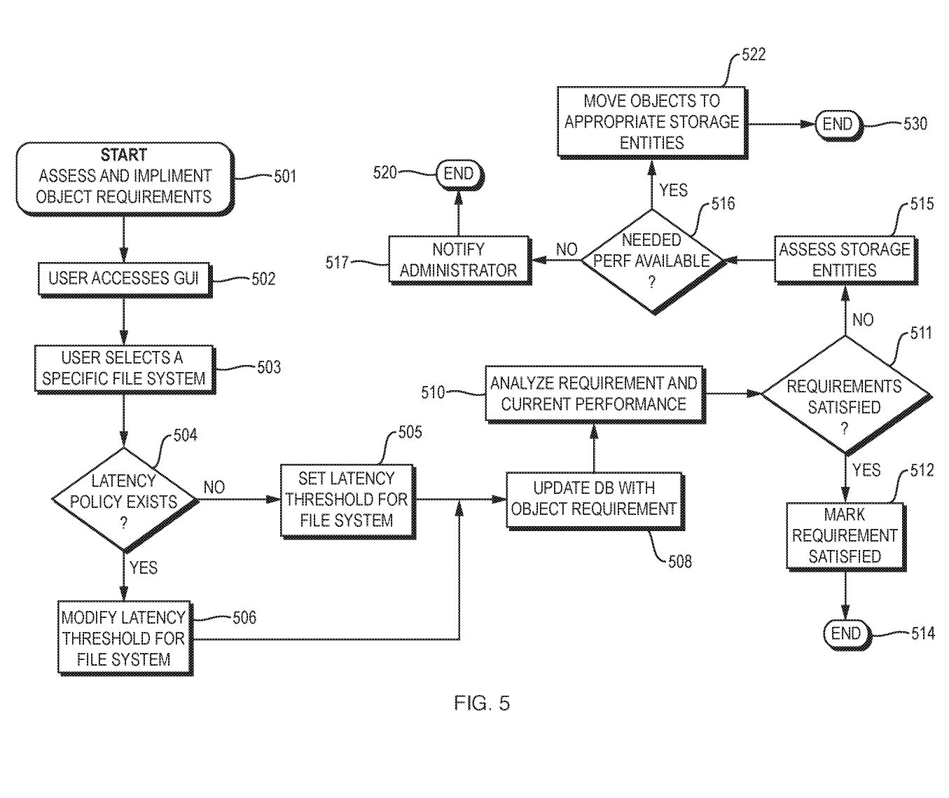

By way of example, a description of an object requirement is shown in FIG. 5. In this example, an object requirement for performance may be defined by the user to indicate that a particular file system must have an average latency of less than twenty milliseconds. The user supplies this input to the data management node through the graphical user interface in steps 502 and 503. This particular requirement would be associated in the database with the file system in question, and each object in that file system would therefore be aware of the requirement by way of association in the database. This object requirement for performance, along with the latest storage classification information, would be passed to the policy engines for analysis. In general, after evaluating the requirement relative to the set of data storage entities that could fulfill the requirement, making use of the data storage entity classification information in the database, the policy engines would supply marching orders for the set of objects in the file system that required relocation in order to meet the performance requirement, if any.

More particularly, step 504 may determine if a latency policy already exists. If no latency policy exists, then a threshold is set in step 505. If a latency policy already exists, then step 506 modifies its threshold per the input from steps 502 and/or 503. Next, in step 508, the database 206 is updated with this new requirement. Step 510 analyzes the latency requirement and current performance available from the data storage entities 130. If the requirements are satisfied, step 512 marks them as such and then step 514 ends this process. Otherwise, step 515 assesses available storage entities and if the requested performance is available in step 516, step 522 moves the objects associated with the access request to the new appropriate entities and then ends this process in step 530. If step 516 cannot find appropriate entities, then an administrator can be notified in step 517 before ending this process.

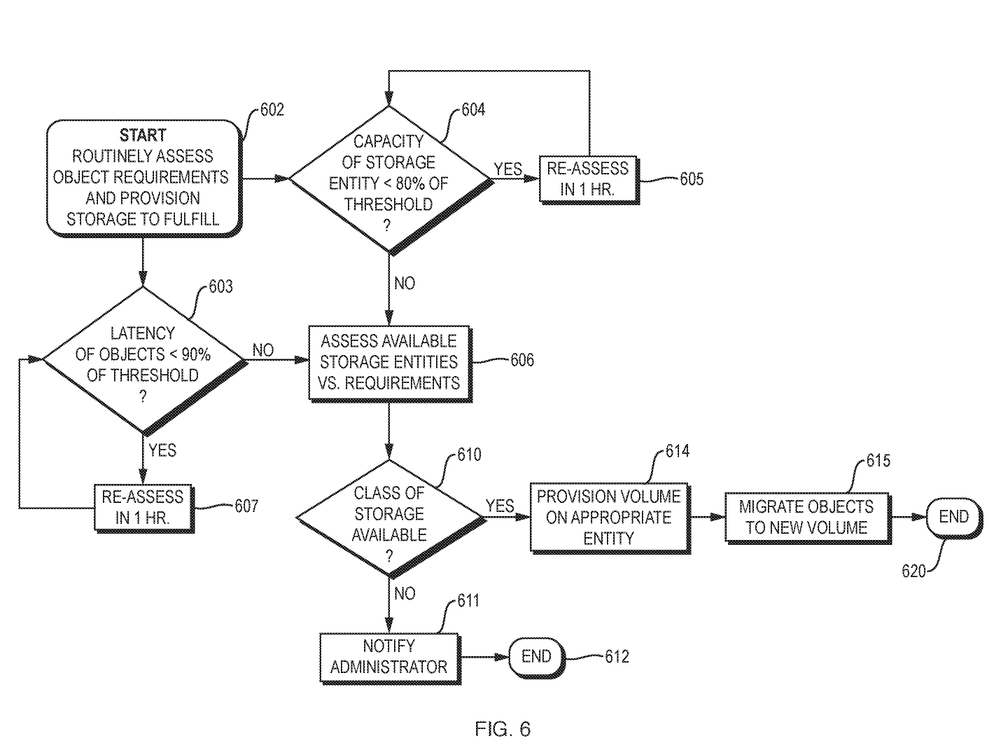

By way of example, a method to routinely assess object requirements and provision data storage entities to accommodate those requirements is shown in FIG. 6. In this example a data management solution 100 may consist of a pair of data management nodes 120, and data storage entities 130 including one or more hard drive arrays in a regional cloud, delivered as IaaS, on more legacy on-premises storage appliances, and one or more all flash arrays in a regional cloud, delivered as IaaS. The performance and capacity needs of the environment, being tracked by the data management node via storage allocation assessments and real-time analysis of data requests, could fail to be satisfied over time as the result of increased utilization of the IaaS platform from other workloads. The data management node may make this determination in a number of ways. First, to determine the capacity needs, the data management node in state 602 routinely assesses object requirements and provisions appropriate storage entities. For example, it may keep daily records of the growth in storage capacity utilization across all data storage entities within the solution, and retains this data for a period of five years in the database. On a routine basis, the data management node thus performs projection calculations on the growth of data within the solution from a daily, weekly, monthly, semi-annual and annual perspective, and makes predictions as to how data will continue to grow over those same periods given legacy statistics. Second, to determine the performance needs, the data management node keeps records in the database of latency (in steps 603 and/or 604), throughput, input/output operations, and queue depth on a per object and per operation (read/write) basis (such as in steps 604 and/or 605), and consolidates those data points in a storage efficient manner by periodically aggregating and averaging. On a routine basis, the data management node performs utilization calculations given those variables, and determines what the performance capability of the solution is and the degree to which it is utilized such as in step 606. The data management node may then perform projection calculations taking into account historical utilization and growth in utilization to make predictions as to how performance requirements will change given legacy statistics. Having determined that not only additional capacity is needed, but also additional performance, the data management node would assess the utilization of underlying storage entities in the regional cloud in steps 610 and 611, determine which entity or entities are best able to service the projected need in step 614, provision them accordingly, and migrate data in step 615.

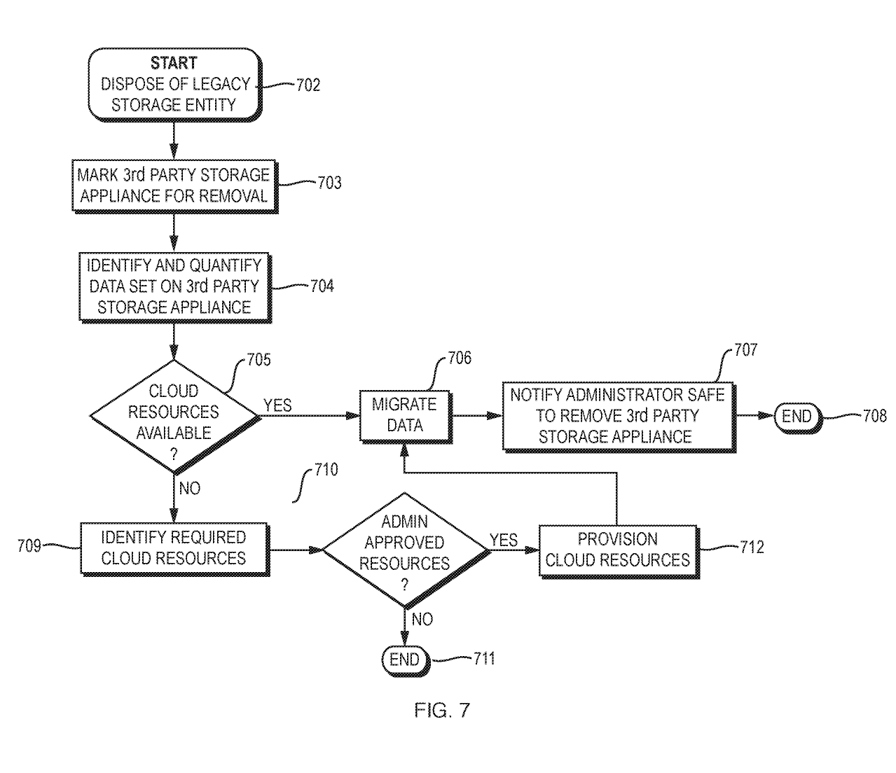

Further extending the above example, a method to dispose of a legacy data storage entity is shown in FIG. 7. The user may decide in step 702 that he wishes to remove a legacy storage appliance from the solution. In such a case, the user may mark that appliance for removal in step 703, such as in the graphical user interface of one of the data management nodes, and indicate the date by which he would like to be able to remove the asset. The request for asset removal may be stored in the database, and the policy engines in step 705 receive the request and determine if sufficient capacity and performance capability existed in the solution to meet all known object requirements independent of the presence of the asset in question. If sufficient cloud resources are already provisioned, step 706 can begin the cloud migration. If the data management node determined in step 705 there was not sufficient capability in the solution to meet the requirements, it may identify and suggest to the user in step 709 the set of cloud assets that would be required to meet the requirement independent of the asset in question. The customer may then be able to approve in step 710 of the provisioning of those cloud assets. At this time, the node may determine via the policy engines that removal of the asset could be achieved, provision the resources in step 712, and begin the process of migrating data off of the asset in question and in the required timeframe in step 706.

From step 706, migration may be performed completely transparently to any of the application or file servers in question. Upon completion of the migration, the user could be notified in step 707 that the legacy storage appliance could be unplugged and removed from the solution with no interruption of service to any of application or file servers.

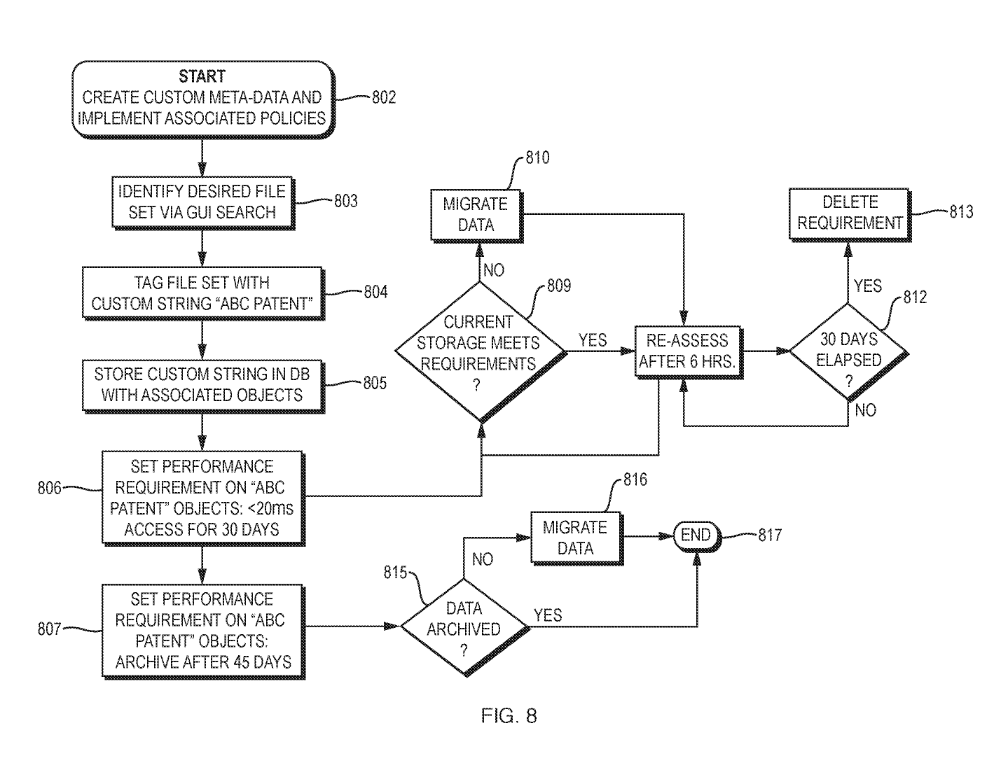

By way of example, a method for using custom, user-defined meta-data to define and fulfill a data management policy is shown in FIG. 8. It is classically the case that businesses have a particular project that requires access to specific files for a general period of time. For instance, a law firm may need access to patent documents, drawings, supporting documentation, and associated research files to fulfill the business need of submitting a client patent application within 30 days. In the unstructured data world, these files may or may not reside on the same data storage entity, may or may not reside in the same file system, and may or may not reside in the same folder. In such a case, the user could access the graphical user interface of one of the data management nodes in step 802, select the set of files associated with the project in step 803, and apply custom meta-data to them, such as the string “Patent Application for ABC Corporation” in step 804 and store it in the database in step 805. Having defined the custom meta-data associated with the file set, the user could now use that meta-data to associate a policy with those files. For instance, the user could indicate a performance requirement in step 806, such as a need to make the file set associated with “Patent for ABC Corporation” accessible to network clients with an average latency of twenty milliseconds. Additionally, the user could indicate in step 807 the requirement to archive the file set associated with “Patent for ABC Corporation” to the lowest cost data storage entity after 45 days. As with other embodiments, steps 809, 810, 811, 812 and 813 may assess whether currently available data entities meet the requirements, and if not, initiate migration. Similarly, steps 815, 816 and 817 may migrate data to be archived.

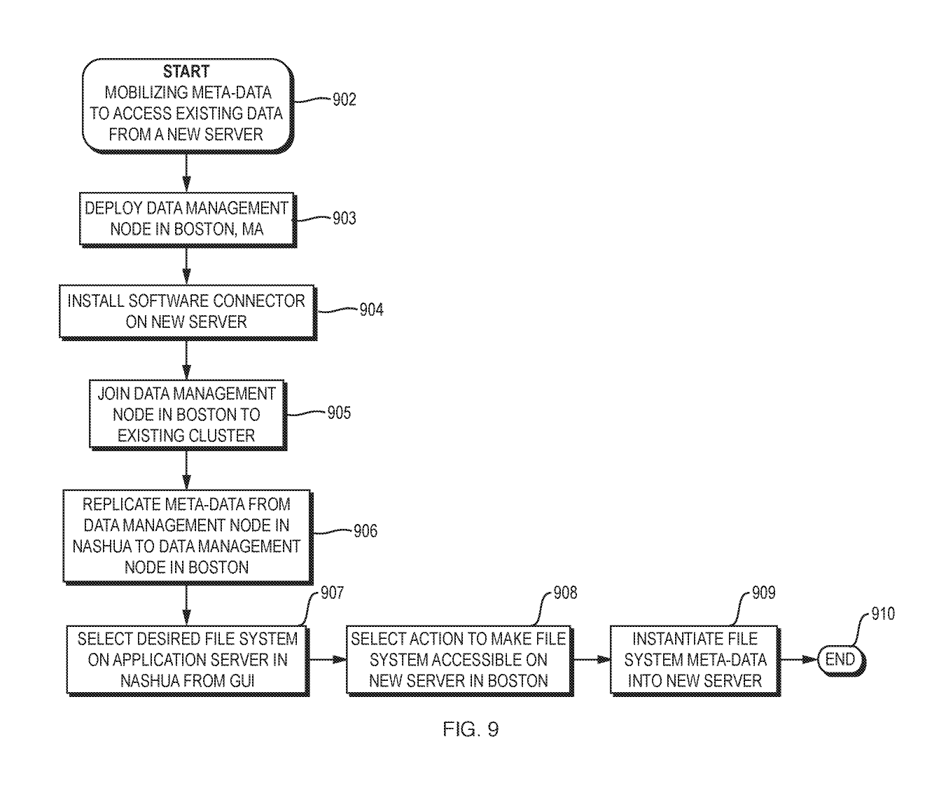

By way of example, a method for using the disclosed to system to mobilize meta-data and enable data to be accessed in another location without moving the associated data is shown in FIG. 9. In one example, meta-data for a specific application server may be stored in a data management node that resides in Nashua, N.H., which also is where the application server generates the data. The associated data objects for this application server, as managed by the data management node, may reside in a regional cloud in a different location such as Boston, Mass., using IaaS object storage. In this example, an employee in Boston, Mass. may wish to run data analysis processes on the data generated in Nashua, N.H. Since the data stored in the regional cloud are data objects known only to the data management node in Nashua N.H., they cannot be read in Boston, Mass. without the use of a data management node. Rather, another data management node may be deployed in Boston, Mass., and by joining a cluster along with the data management node in Nashua, N.H., can gain authenticated access to the data objects stored in the regional cloud. The process of making the data accessible in Boston, Mass. entails what is called file system instantiation; that is, deploying a file system, using the meta-data accessible to the data management node, into the desired server, via a software connector component.

Thus, in a first step 902, the system identifies a need to mobilize meta-data to permit access to existing data objects by a new server in Boston, Mass., such as via user input or via automated analysis of access requirements. In step 903, a new data management node is deployed in the new region. In step 904, a new connector component is installed on the new server. Step 905 joins the new data management node to the existing data management node cluster in Nashua, N.H. Step 906 replicates the meta-data between data management nodes—but the data objects themselves remain in the data storage entities. Steps 907, 908, and 909 then instantiate a file system on the new server (again, without copying actual data objects or files).

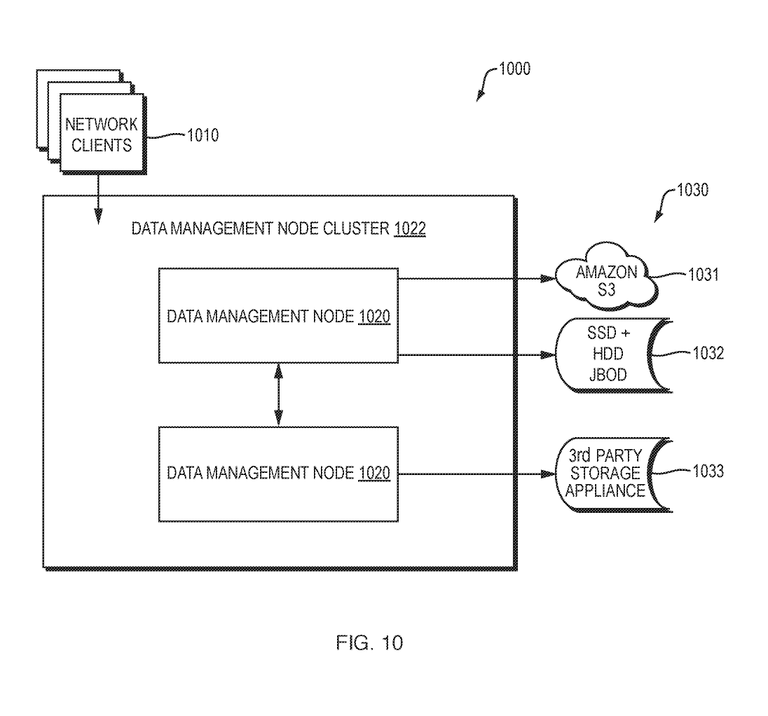

FIG. 10 is one example embodiment of a cloud data management solution 1000 that is accessible directly by network clients 1010 without using connectors 112 as in FIG. 1.

The illustrated data management solution 1000 comprises one or more network clients 1010 connected to one or more data management nodes 1020, and data management nodes connected to one or more data storage entities 1030.

Multiple data management nodes 1020 may be present for the purposes of redundancy.

Network clients 1010 may connect to the data management nodes 1020 via standard network data protocols, such as but not limited to NFS, SMB, iSCSI, or object storage protocols such as Amazon S3.

Data management nodes 1020 can exist in a cluster 1022 or as standalone entities. If in a cluster 1022, data management nodes 1020 communicate with each other via a high speed, low latency interconnect, such as Infiniband or 10 Gigabit Ethernet.

Data management nodes 1020 also connect to one or more data storage entities 1030.

Data storage entities 1030 may include any convenient hardware, software, local, remote, physical, virtual, cloud or other entity capable of reading and writing data objects including but not limited to individual hard disk drives (HDD's), solid state drive (SSD's), directly attached JBOD enclosures thereof, third party storage appliances (i.e. EMC), file servers, and cloud storage services (i.e. Amazon S3, Dropbox, OneDrive, etc.).

Data storage entities 1030 can be added to the data management solution 1000 without any interruption of service to connected network clients 1010, and with immediate availability of the capacity and performance capabilities of those entities.

Data storage entities 1030 can be targeted to be removed from the data management system, and after data is transparently migrated off of those data storage entities, can then be removed from the system without any interruption of service to network clients.

The data storage methods and systems described herein provide for decoupling of data from related meta-data for the purpose of improved and more efficient access to cloud-based storage entities.

The methods and systems described herein also enable replacement of legacy storage entities, such as third party storage appliances, with cloud based storage in a transparent online data migration process.

Specific data access requirements, service levels (SLAs) and policies needed to implement them are also supported. These requirements, service levels, and policies are also expressed as metadata maintained within a database in the data management node. The system also provides the ability to measure and protect growing data requirements and identify and deploy data storage entities required to fill those requirements. User-defined metadata may also be stored with the system-generated meta-data and exposed for further use in applying the policies and/or otherwise as the user may determine.

In other aspects, the systems and methods enable global migration of objects across heterogeneous storage entities.

What is claimed is:

1. A method for operating a data management node comprising:
receiving an access request from a remote device;
interpreting the access request to determine how to handle the access request as a request to access one or more data objects;
forwarding the access request to one or more data storage entities that store data objects remotely from the data management node;
in a database local to the data management node, storing an object record that includes:
file system metadata associated with the access request;
an object signature and storage location descriptor for identifying and/or locating the one or more data objects in the one or more data storage entities;
at least one metadata attribute relating to at least one of management, policy enforcement, and/or service levels for the access request;
in a database local to the data management node, also storing, as one or more metadata structures:
information concerning users, groups of users, application servers, file servers, files, and/or file systems related to the access request;
at least one attribute relating to at least one of management, policy enforcement, and/or
service levels for the access request;
thereby enabling deployment of data storage entities that store data objects independently of other data management functionality.

2. The method of claim 1 additionally comprising:
keeping only a non-persistent copy of the data object on the data management node.

3. The method of claim 1 additionally comprising:
receiving a policy specifying an aspect of management of at least one of the data objects;
operating a policy engine for comparison of the at least one data object attribute against the policy; and
moving the at least one data object to a differently classified data storage entity based on the result of the comparison.

4. The method of claim 1 wherein the data access request is received from a software connector component resident in-situ within an operating system.

5. The method of claim 4 wherein the data access request is received as a result of a filtering operation performed by the software connector component.

6. The method of claim 1 wherein the data storage entities comprise one or more of physical storage, virtual storage, cloud storage, IaaS, regional cloud, JBOD, and/or a storage appliance.

7. The method of claim 1 wherein the storage location descriptor specifies a logical block address or volume identifier.

8. The method of claim 1 wherein the storage location descriptor specifies an object identifier.

9. The method of claim 1 additionally comprises the steps of, in a background process separate from receiving an access request from a remote device:
reading a data object from the selected one of the data storage entities;
writing the data object to a second selected one of the data storage entities;
updating an object record for the data object with a storage location identifier that points to the second selected one of the data storage entities; and
subsequently deleting the data object from the first selected one of the data storage entities.

10. The method of claim 1 additionally wherein:
the object record stores at least one attribute that characterizes the data storage entity that stores the data object.

11. The method of claim 10 wherein the at least one attribute is an access speed requirement.

12. The method of claim 1 wherein a user-defined policy specifies a data retention time for the data object.

13. The method of claim 1 wherein an attribute of the data storage entity includes one or more of performance, capacity, data optimization, disaster recovery, retention, disposal, security, cost, or a user-defined attribute.

14. The method of claim 1 wherein the policy specifies a storage optimization attribute.

15. The method of claim 9 where the storage optimization attribute is de-duplication.

16. The method of claim 1 wherein at least two data storage entities are of a different storage classification.

17. The method of claim 1 additionally comprising:
monitoring remaining capacity of at least one data storage entity over time;
automatically identifying at least one additional data storage entity when the remaining capacity reaches a predetermined amount; and
migrating one or more data objects to the additional data storage entity.

18. The method of claim 1 wherein the object record includes a user-defined attribute applicable to one or more objects and further comprising:
enforcing at least one data management policy according to the user-defined attribute.

19. The method of claim 1 wherein the connector component additionally performs the steps of:
receiving a command to assume responsibility for processing access requests to one or more data assets accessible to the remote device;
storing a persistent cookie associated with the one or more data assets;
upon subsequent processing of an access request related to a specific data asset,
if the persistent cookie is associated with the data asset,
then
forwarding the access request to the data management node;
else
processing the access request in the remote device without forwarding the access request to the data management node.

20. The method of claim 1 additionally comprising:
connecting to an other one of the data management nodes in a cluster;
receiving an instruction that a data asset is to be accessible through the other data management node in the cluster;
replicating meta-data relating to the data asset to the other data management node;
updating the metadata to indicate that the data asset is now accessible to the other data management node.

21. The method of claim 18 additionally comprising
instantiating a file system on another server accessible to the other management node without moving the data asset; and
installing a connector on the other server accessible from the other management node.
